(19) United States
(12) Patent Application Publication
(10) Pub. No.: US 2002/0161660 A1
(43) Pub. Date: Oct. 31, 2002

(54) Comprehensive system and method for providing research, community, design, and purchasing services over a computer network

(76) Inventors: Suzanne Marie Giardino, Pittsfield, MA (US); John Lesica, Stoughton, MA (US)

Correspondence Address: Robin C. Clark, Esq., Hunton & Williams, Suite 1200, 1900 K Street, NW, Washington, DC, 20006-1109, US

(21) Appl. No.: 09/844,708

(22) Filed: Apr. 30, 2001

(51) Int. Cl. G06F 17/60

(52) U.S. Cl. 705/26

(57) ABSTRACT

A comprehensive system and method for providing industry-related research, community, design, and purchasing services over a computer network including the step of receiving, from a client computer associated with a user, a request to view a home page associated with a service provider. In response to this request, a home page is displayed to the client computer, wherein the home page includes thereon at least the following options: a research option, an interact option, a design option, and a buy option. A request is received from the client computer to select a selected one of the research, interact, design, and buy options. In response to this selection, content associated with the selected one of the research, interact, design, and buy options is displayed to the client computer.

### BACKGROUND OF THE INVENTION

The present invention relates generally to systems and methods for providing information and related services to users over a computer network. More particularly, the present invention relates to a comprehensive system and method for providing research, community, design, and purchasing services to users in an on-line environment.

Recent advances in communication, the Internet in particular, have facilitated both the general exchange of information as well as on-line commerce by exposing users to a vast collection of information, vendors and the goods for sale by the vendors. The growth of the Internet over the last several years has been explosive, fueled in the most part by the widespread use of software viewers known as browsers which allow a simple graphical user interface to communicate information electronically between a plurality of different platforms. The Internet has become ubiquitous in businesses and homes because it has proven to be convenient for various applications, such as news and data delivery, conducting banking and investment transactions, and the like.

In addition to simple exchanges of information, the Internet has become a primary vehicle for purchasing goods and services. By enabling users and vendors from geographically remote locations to instantaneously interact, conventional rules relating to sales techniques and customer service are changing by the day. Further, the increased speed at which information is exchanged and purchases are made has the potential to render markets more efficient. However, with the increase in the number of commercial transaction-based web sites, there is an increased risk of a decreased level of service being provided by customers.

Further, in many instances, the actual commercial transaction is merely a culmination of a large amount of preliminary work conventionally undertaken by the consumer. For example, in most industrial circumstances, a decision on whether to purchase a particular chemical or bulk raw material is made only after completing a thorough decision-making process. Further, relating to new products, such a decision can only be made following the completion of a product development and design process. Present transaction-based web-sites completely fail to recognize these critical steps in the overall material purchasing process by servicing only the final component in the process, the purchase.

Therefore, there remains a need in the art of on-line commercial transaction systems for a system which address the deficiencies of present systems in relation to providing services related to education, design, and collaboration as well as commercial transactions.

### BRIEF SUMMARY OF THE INVENTION

The present invention overcomes the problems noted above, and provides additional advantages, by providing a system and method for providing industry-related research, community, design, and purchasing services over a computer network including the step of receiving, from a client computer associated with a user, a request to view a home page associated with a service provider. In response to this request, a home page is displayed to the client computer, wherein the home page includes thereon at least the following options: a research option, an interact option, a design option, and a buy option. A request is received from the client computer to select a selected one of the research, interact, design, and buy options. In response to this selection, content associated with the selected one of the research, interact, design, and buy options is displayed to the client computer.

By providing a comprehensive system of information sharing/electronic commerce services, the present invention substantially simplifies and streamlines the overall product designing and fabrication/manufacturing experience. Further, by enabling users to research, interact, design, and purchase all in one coherent environment, the present invention substantially reduces the likelihood of ordering errors and the like which may accompany utilizing services from a plurality of different vendors.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of a computer network suitable for implementing a method and system according to the present invention;

FIG. 2 is a flow chart describing one embodiment of a method for providing research, community, design, and purchasing services over the network of FIG. 1;

FIG. 3 is a flow chart describing one embodiment of the research option disclosed in FIG. 2;

FIG. 4 is a flow chart describing one embodiment of the interact option disclosed in FIG. 2;

FIG. 5 is a flow chart describing one embodiment of the design option disclosed in FIG. 2;

FIG. 6 is a flow chart describing one embodiment of the buy option disclosed in FIG. 2; and

FIG. 7 is a flow chart describing one embodiment of a method for developing a product utilizing the system of the present invention.

### DETAILED DESCRIPTION OF THE INVENTION

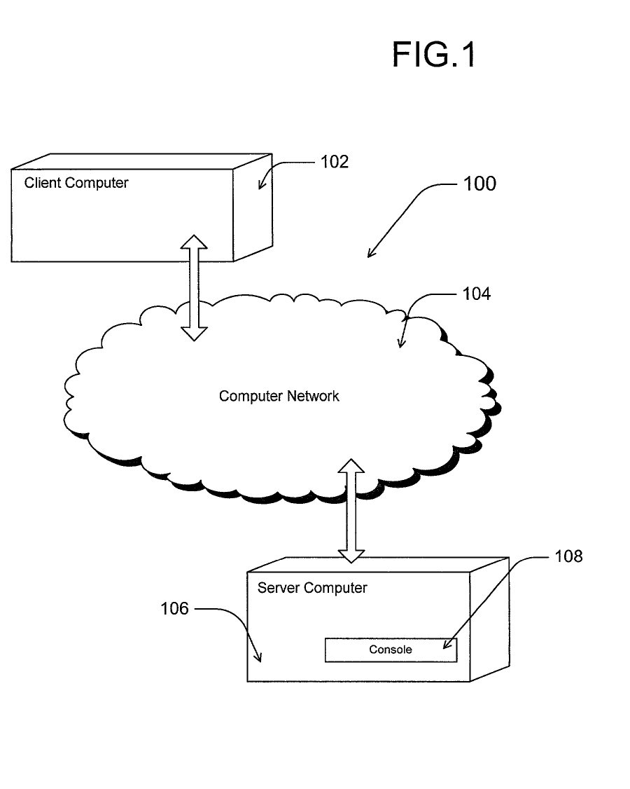

An Internet computer system 100 is generally illustrated in FIG. 1. A conventional client computer system 102, executing a client browser application that supports the HTTP protocol, is connected typically through a network service provider to a suitable computer network 104 such as the Internet.

Client computer system 102 may include, for instance, a personal computer running the Microsoft Windows™ 95, 98, Millenium™, NT™, or 2000, Windows™CE™, PalmOS™, Unix, Linux, Solaris™, OS/2™, BeOS™, MacOS™ or other operating system or platform. Client computer system 102 may also include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. Furthermore, client computer system 102 may include electronic memory such as RAM (random access memory) or EPROM (electronically programmable read only memory), storage devices such as a hard drive, CDROM or rewritable CDROM or other magnetic, optical or other media, and other associated components connected over an electronic bus, as will be appreciated by persons skilled in the art. Client computer system 102 may also include a network-enabled appliance such as a WebTV™ unit, radio-enabled Palm™ Pilot or similar unit, a set-top box, a networkable game-playing console such as Sony Playstation™ or Sega Dreamcast™, a browser-equipped cellular telephone, or other TCP/IP client or other device.

In addition to the Internet, suitable computer networks may also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.92, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, computer network 104 may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Computer network 104 may yet further include or interface with any one or more of an RS-232 serial connection, an IEEE-1394 (Firewire™) connection, a Fibre Channel connection, an IrDA (infrared) port, a SCSI (Small Computer Systems Interface) connection, a USB (Universal Serial Bus) connection or other wired or wireless, digital or analog interface or connection.

A server computer system 106 is also coupled typically through an Internet Service Provider to the computer network 104. The server computer system 106 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The server computer system 106, controlled by a local console 108, executes at least one web server application conventionally known as a HTTPd server. In addition, the server computer system 106 preferably provides local storage for at least one, though typically many, web pages as files in HTML format and/or other formats. Preferably, a plurality of pricing schedules are also stored in the memory device of server computer system 106. These various pricing schedules are described in additional detail below. Also, server computer system 106 may include several individual server computers at various locations on the network.

The client computer system requests a web page by issuing a URL request through the Internet 104 to the server system 106. A URL consistent with the present invention may be a simple URL of the form:

<protocol_identifier>://<server_path>/<web_page_path>

A “protocol_identifier” of “http” specifies the conventional hyper-text transfer protocol. A URL request for a secure Internet communication session typically utilizes the secure protocol identifier “https,” assuming that the client browser and web server each support and implement the secure sockets layer (SSL). The “server_path” is typically of the form “prefix.domain,” where the prefix is typically “www” to designate a web server and the “domain” is the standard Internet sub-domain.top-level-domain of the server system 106. The optional “web_page_path” is provided to specifically identify a particular hyper-text page maintained by the web server.

In response to a received URL identifying an existing web page, the server system 106 returns the web page, subject to the HTTP protocol, to the client computer system 102. This web page typically incorporates both textural and graphical information including embedded hyper-text links, commonly referred to as hyperlinks, that permit the client user to readily select a next URL for issuance to the computer network 104.

The URL issued from the client system 102 may also be of a complex form that identifies a common gateway interface (CGI) program on a server system 106. Such a HTML hyperlink reference is typically of the form:

<form action=“http://www.vendor.com/cgi-bin/logon.cgi”method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

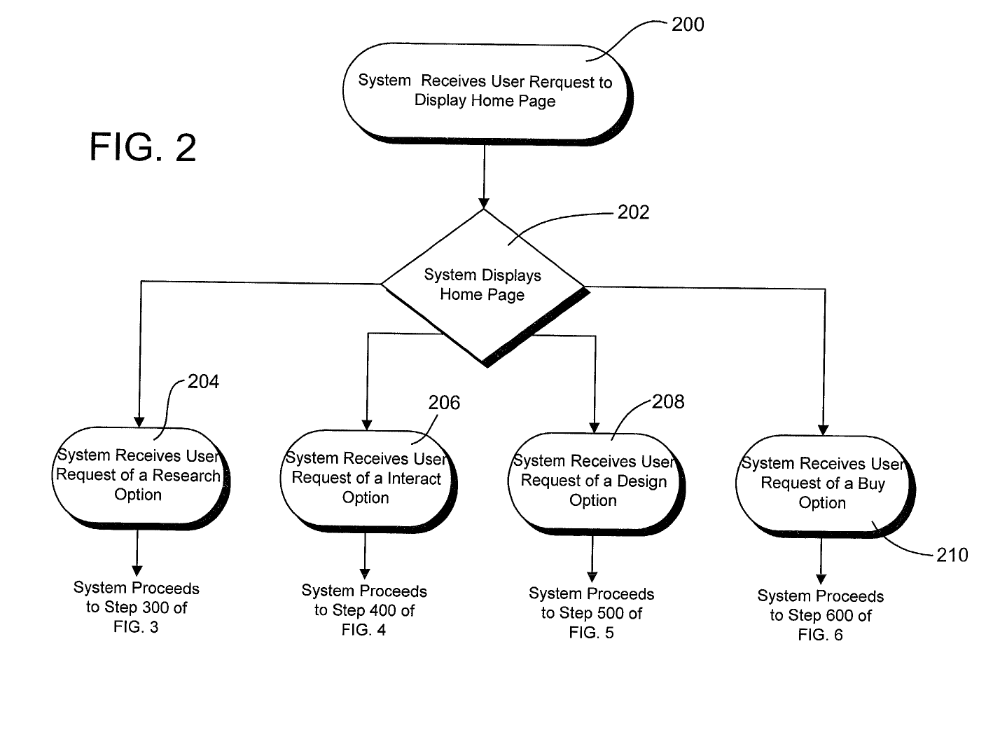

Referring now to FIG. 2, there is shown a flow chart describing one embodiment of a method for interactively providing research, community, design, and purchasing services in a related industry over a computer network. One example of a suitable industry is the bulk chemical or plastics industry, although the method and system of the present information is adaptable to any industry involving the design, assembly, or manufacture of a product or part. For example, the sheet metal, alloy, and ceramics industries would all particularly benefit from the system and method disclosed herein.

Preferably, the method and system described below is implemented by a computer software program, such as a web server application, resident on one or more server computers (such as server computer system 106, described above) associated with a content provider. Preferably, such a web server application is utilized to create and maintain a plurality of dynamically interactive web pages on the server computer(s). In a preferred embodiment, users of the system are connected to the server-hosted web pages through the browser applications (e.g., Microsoft Internet Explorer™ and Netscape Navigator®) of a plurality of client computers (such as client computer system 102) over the computer network 104. In this manner, system users may remotely interact with the servers to obtain, exchange, or modify information as more fully set forth in detail below.

Although not limited thereto, computer software programs for implementing the present method may be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

In step 200, the content provider's server computer system (hereinafter generally referred to as “the system”) receives a request from a user's client computer system (hereinafter referred to as “the user”) to display a home page which briefly describes the nature of the services and features provided by the system and which includes thereon a plurality of user options, or hyperlinks, the selection of which results in user navigation to the selected content item or site feature.

As is known in the art, a home page is, generally speaking, the first page of a web site, or a collection of related web pages and provides a starting point for enabling a user to navigate through the site in an orderly, user-friendly manner. Accordingly, the present home page is a starting point for the information sharing/electronic commerce system of the present invention. In step 202, the system displays the home page on the user's client computer system via the computer network in the manner described above. Following display of the home page, the user may select from a plurality of options related to at least the following general features: 1) researching material selection and processing guidelines; 2) interacting with industry peers and colleagues regarding problems, suggestions, and career moves; 3) designing end use products using provided guidelines and other resources; and 4) purchasing materials from a plurality of resin manufacturers. In addition, several customer service and account administration features are also available to assist users in managing their past and present orders. It should be understood that these options may be displayed to users on a single web page interface or under discrete web page interfaces corresponding generally to the various site options, respectively. In this manner, any desired level of page simplicity may be obtained.

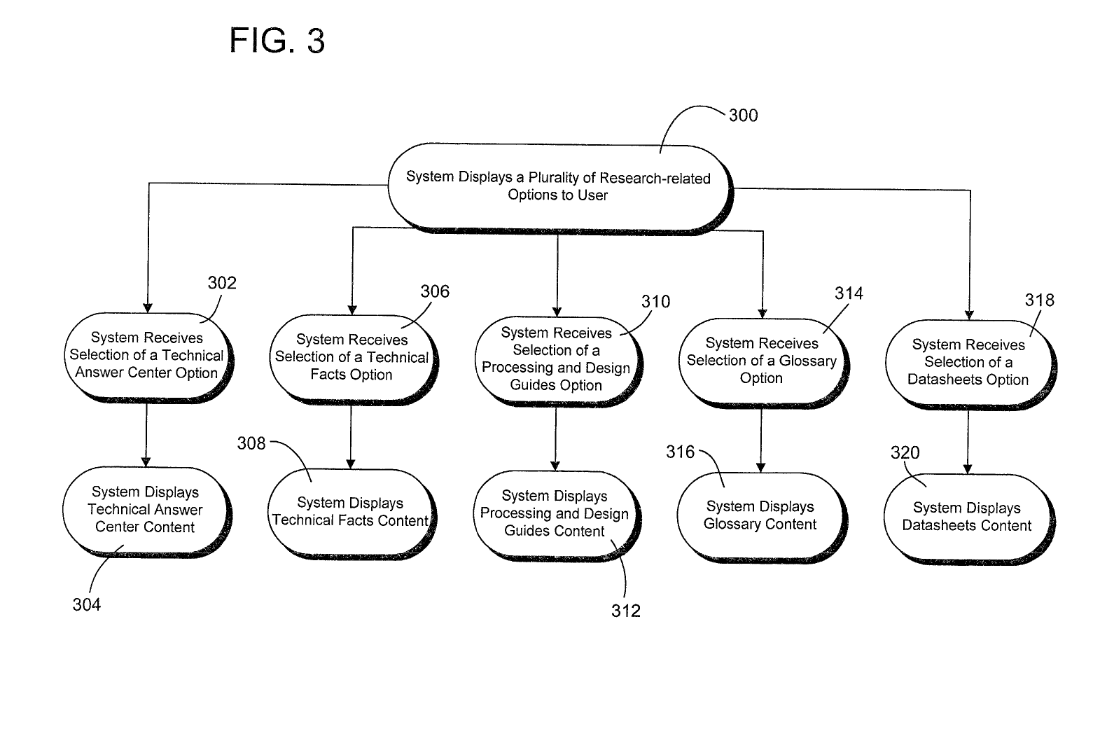

In accordance with the above-described options, detailed description of each option will now be set forth below. In step 204, the system receives a user selection of a research option. Upon receipt of such a request, the system, in one embodiment, proceeds to step 300 of FIG. 3, and displays a research web page to the user. Preferably, the procedure research page includes at least a listing of all available options related to material and processing research. In an alternative or complementary embodiment, selection of the research option results in an immediate pop-up display of the several related options, without requiring the loading of an entirely new web page. In one embodiment, such a pop-up display is implemented through the use of javascript technology. The details of various research options will be described in additional detail below.

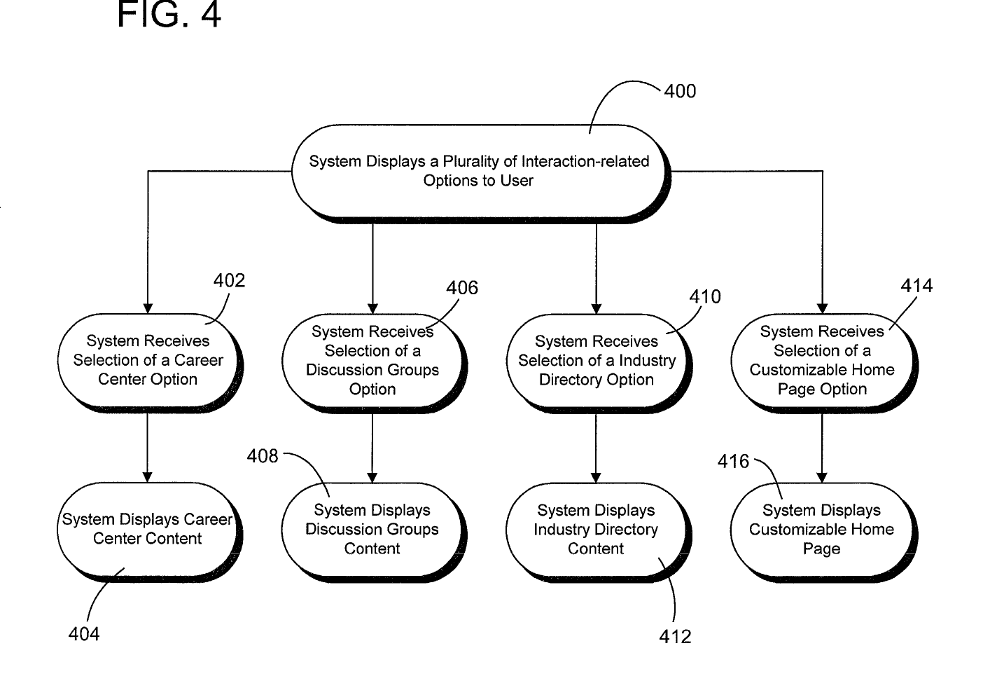

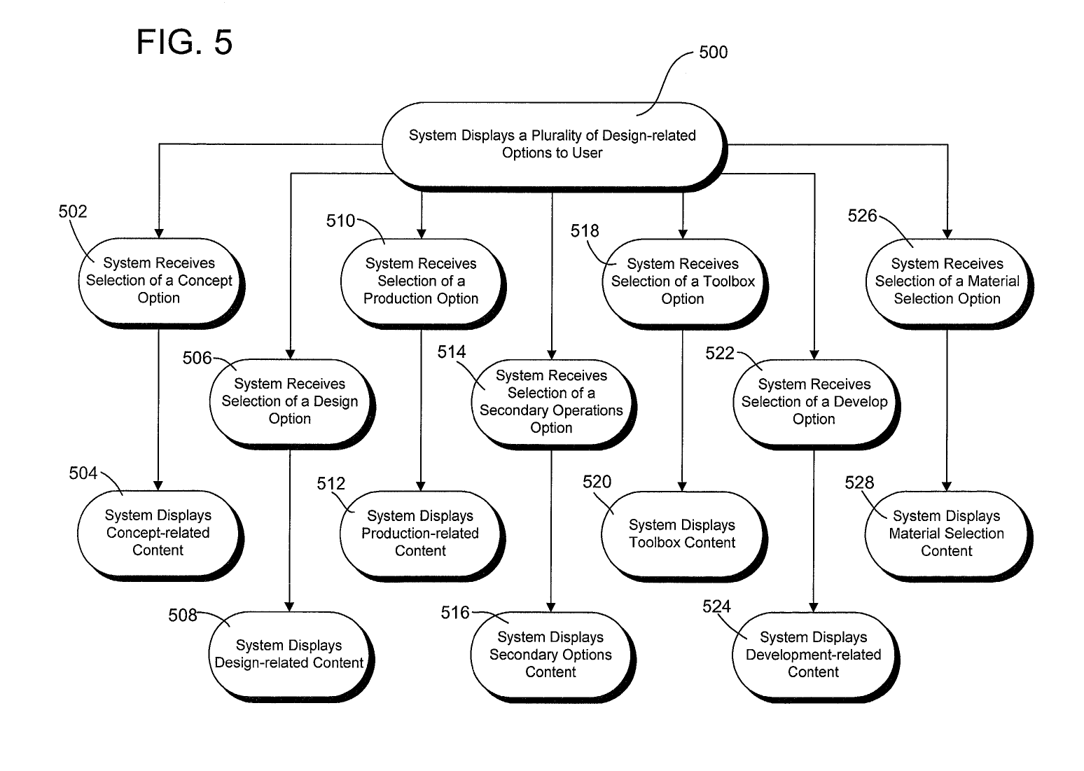

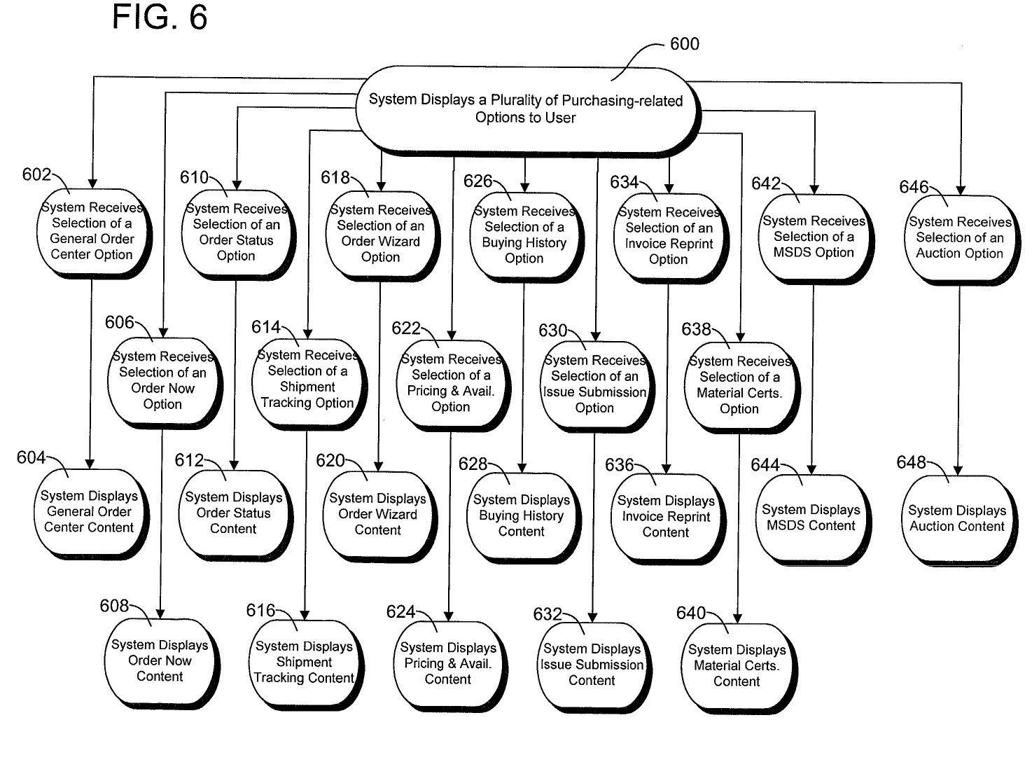

In step 206, the system receives a user selection of a ‘interact’ option. Similar to that described above, upon receipt of this selection, the system proceeds to step 400 of FIG. 4, and displays a listing of user interaction-related options, either in a separate web page or in a pop-up display. The details of various interact options will be described in additional detail below. In step 208, the system receives a user selection of a ‘design’ option. As above, receipt of this selection results in the display of a plurality of design-related options in step 500 of FIG. 5, more fully described below. In step 208, the system receives a user selection of a ‘buy’ option. In response, the system proceeds to step 600 of FIG. 6, wherein a plurality of material ordering-related options are displayed to the user. Additional details of FIG. 6, will be set forth in additional detail below.

Although each of the above described options are described as stemming from the home page, it should be understood that each of the options may be displayed in such a manner as to be available for user selection from any of the various content pages included within the site. For example, frames technology may be employed, wherein the client's browser display is segmented into various elements, with several of the elements remaining static regardless of user navigation. This technology enables anchoring of the user's experience to the base system options, regardless of particular content element currently being displayed.

By collectively providing a plurality of services related to researching, interacting, designing, and purchasing over a computer network, the present invention substantially enhances and streamlines the customer's ability to both create and build products meeting their specific needs. As is understood in the art, the various options available under each of the four major categories may take any suitable form including additional web pages, third party links, java tools, etc. and, although exemplary details of these options will be set forth in detail below, these should not be read as limitations upon the inventive methodology described herein.

Referring now specifically to FIG. 3, in step 300, the system displays a plurality of research-related options to the user. In one embodiment specifically directed toward the plastics industry, the following options are provided: 1) a technical answer center option; 2) a technical facts option; 3) a processing and design guides option; 4) a glossary option; and 5) a material datasheets option. In step 302, the system receives a user selection of the technical answer center option. In response, the system, in step 304, displays content related to providing users with information about the various materials distributed through the site. This content may include further user-selectable options and other interactive elements for accurately determining what information will meet the user's particular needs.

In step 306, the system receives a user selection of the technical facts option. In response, the system, in step 308, displays content including searchable/sortable technical information such as processing parameters, secondary operations and technical tips for supplied materials as well as troubleshooting tips user may find helpful. In step 310, the system receives a user selection of the processing and design guides option. In response, the system, in step 312, displays an on-line order form for enabling users to order design and processing guides for selected materials. In step 314, the system receives a user selection of the glossary option. In response to this selection, the system, in step 316, displays content which includes indexed glossaries of both technical and design terms. In step 318, the system receives a user selection of the material datasheets option. In response to this selection, the system, in step 320, displays content which includes a searchable listing of the various products available through the site. The listing for each of these products further includes a viewable datasheet for the product, describing the product's features, uses, ratings, properties, etc.

Turning now to FIG. 4, in step 400, the system displays a plurality of interaction-related options. In one embodiment, these options may include: 1) a career center option; 2) a discussion groups option; 3) an industry directory option; and 4) a customizable home page option. In step 402, the system receives a user selection of the career center option. In response to this selection, the system, in step 404, displays content designed to provide users with a wealth of information related to finding or posting jobs in the relevant industry. In step 404, the system receives a user selection of the discussion groups option. In response to this selection, the system, in step 406, displays content which includes a listing of all available discussion groups where users can read and post message to a forum of their peers and colleagues, in a known manner.

In step 410, the system receives a user selection of the industry directory option. In response to this selection, the system, in step 412, displays content which preferably includes a searchable listing of various vendors in the industry. In step 414, the system receives a user selection of the customizable home page option. In response to this selection, the system, in step 416, displays a customizable version of home page. In one embodiment, each discrete content area is provided with its own frame and may be repositioned and resized within the customized home page. Further, sub-content within each content frame may also be modified at the user's discretion. In this manner, the user may organize the various information options in a manner efficient and useful to themselves.

Once products or materials have been researched and investigated, it becomes necessary to design the particular product that will be produced. Turning now to FIG. 5, there is shown one particular embodiment of the ‘design’ option described briefly above. In step 500 displays a plurality of design-related options to the user. In one embodiment, these options may include: 1) a concept option; 2) a design option; 3) a production option; 4) a secondary operations option; 5) a toolbox option; 6) a develop option; and 7) a material selection option. In step 502, the system receives a user selection of the concept option. In response, the system, in step 504, displays content related to assisting users in conceptualizing a product based upon potential customer considerations, product usage, physical properties, etc. In step 506, the system receives a user selection of the design option. In response, the system, in step 508, displays content related to assisting users in designing the products which they have envisioned using various tools and interactive services.

In step 510, the system receives a user selection of the production option. In response, the system, in step 512, displays content designed to assist users in determining which production method best suits their particular needs and application requirements. In step 514, the system receives a user selection of the secondary operations option. In response, the system, in step 516, displays content designed to assist users in locating and performing secondary operations on the parts they make. Secondary operations include such processes as dyeing, treating, coating, etc. and may be performed on the various products manufactured from the plastics sold and referenced through the site. In step 518, the system receives a user selection of the toolbox option. In response, the system, in step 520, displays a listing of all of the various tools available under the concept, design, product, and secondary operations options set forth above. In this manner, users can navigate to all available tools from one single location.

In step 522, the system receives a user selection of the develop option. In response, the system, in step 524, displays content designed to assist users in developing product applications using interactive mold filling and three dimensional modeling tools which enable multiple users to share information relative to a particular design over the Internet. In step 526, the system receives a user selection of the material selection option. In response, the system, in step 528, displays content which enables the user to search for a locate appropriate materials using a variety of different search methods and databases.

Once a product has been conceptualized, and designed, the system of the present invention further enables users to purchase the various raw materials necessary to actually produce the product. Referring now to FIG. 6, there is described one embodiment of the ‘buy’ option briefly described above. In step 600, the system displays a plurality of material ordering and order administration related options to the user. In one embodiment, these options may include: 1) a general order center option; 2) an order now option; 3) an order status option; 4) a shipment tracking option; 5) an order wizard option; 6) a pricing and availability option; 7) a buying history option; 8) a issue submission option; 9) an invoice reprint option; 10) a material certifications option; 11) a material safety data sheets (MSDS) option; and 12) an auction option.

In step 602, the system receives a user selection of the general order center option. In response, the system, in step 604, displays content related to assisting users in performing all of the various order related options including placement of orders, tracking orders, etc. In step 606, the system receives a user selection of the order now option. In response, the system, in step 608, displays content enabling the user to place new material orders. In 610, the system receives a user selection of the order status option. In response, the system, in step 612, displays content enabling the user to check on the status of pending orders.

In step 614, the system receives a user selection of the shipment tracking option. In response, the system, in step 616, displays content enabling the user to track the location of orders which have been shipped. In step 618, the system receives a user selection of the order wizard option. In response, the system, in step 620, displays content enabling the user to load and create order templates related to particular purchases thereby increasing the ease in which repeated orders are made. In step 622, the system receives a user selection of the pricing and availability option. In response, the system, in step 624, displays content enabling the user to determine the availability and price of particular materials.

In step 626, the system receives a user selection of the buying history option. In response, the system, in step 628, displays content enabling the user to view a listing of their various past orders. In step 630, the system receives a user selection of the issue submission option. In response, the system, in step 632, displays content enabling the user to inform the site operators of problems or concerns related to the ordering experience. In step 634, the system receives a user selection of the invoice reprint option. In response, the system, in step 636, displays content enabling the user to view copies of the invoices for previously ordered materials. In step 638, the system receives a user selection of the material certifications option. In response, the system, in step 640, displays content enabling the user to request copies of certifications corresponding to previously ordered materials. In step 642, the system receives a user selection of the MSDS option. In response, the system, in step 644, displays content enabling the user to view MSDS's for previously ordered materials. In step 646, the system receives a user selection of the auction option. In response, the system, in step 648, displays content enabling the user to bid on aged and off-spec materials.

In a preferred embodiment of the present system, users must first create an account and authenticate themselves with the network server prior to reaching several of the options set forth above, particularly the various material order and tracking options. Further, authentication and account creation may be required by third party providers of several site options. As is known in the art, authentication may take many forms including submission of a unique username/password combination suitable for identifying the user to the server. Additionally, network “cookies” may be used to store authentication information on the user's individual client computer system. In a manner known in the art, upon submission of the system home page URL into the client browser application, the network server may reads the client's “cookie” and obtains the necessary authentication information. Although several methods have been disclosed, it should be understood that any suitable method for authenticating a user to a network server may be used with the present invention.

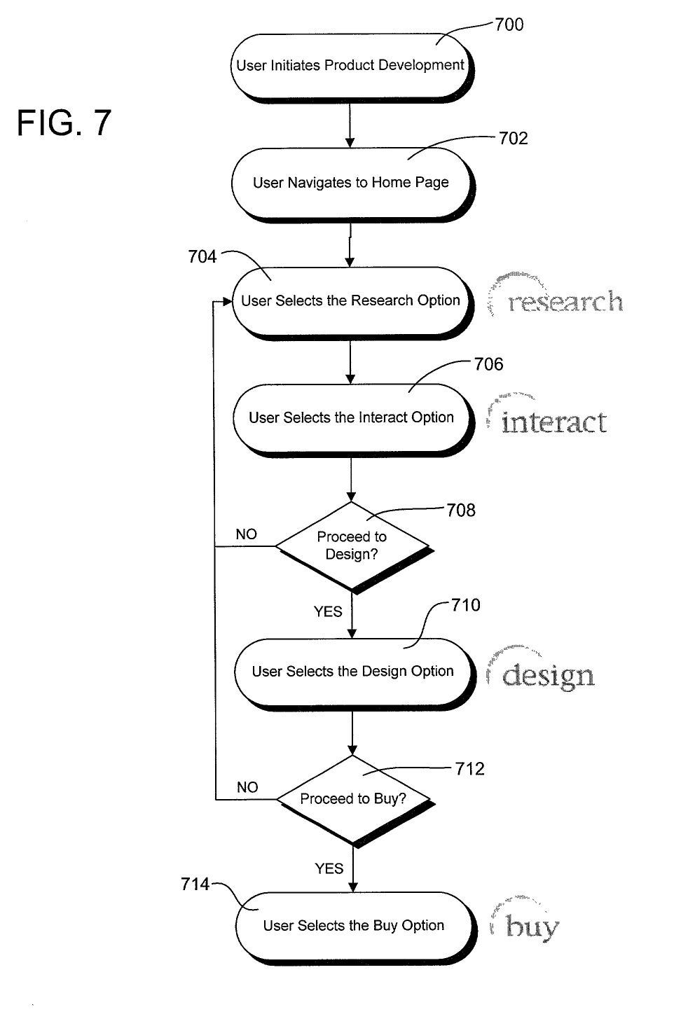

Referring now to FIG. 7, there is shown a generalized flow chart describing one embodiment of a method for developing a product using the system of the present invention. This description illustrates one manner in which users can utilize the variety of features to take a product from conception to production. In step 700, a user decides to initiate product development. In step 702, the user navigates to the home page described above including each of the research, interact, design, and buy options. In step 704, the user selects the research option and conducts research about the various materials available to use in his product and the uses for such materials. Once armed with a certain degree of knowledge and several specific questions, the user proceeds to step 706 and selects the interact option where he may post his questions in an on-line discussion group or otherwise interact with a peer community. In step 708, the user determines whether the information he has learned so far has enabled him to proceed to the design stage. If not, the user can return to the research option in step 704 and conduct additional research.

However, if the user feels confident in his knowledge base, he proceeds to step 710 where he selects the design option and utilizes the available tools and resources to conceptualize, and design his product, as will as its fabrication process. In step 712, the user determines whether he needs to conduct more research and, if so, returns to step 704. However, if the user feels he has developed a workable design, he proceeds to step 714 where he selects the buy option. Here, he can locate and order the various materials required to make his product. Further, once ordered, the buy option enables the user to track the status and shipment of his order, view any associated certifications and MSDS's and review his invoice.

By providing a comprehensive information sharing/electronic commerce system, the present invention substantially simplifies the overall product designing and manufacturing experience. Further, by enabling users to research, interact, design, and purchase all in one coherent environment, the present invention substantially reduces the likelihood of ordering errors and the like which may accompany utilizing services from a plurality of different vendors.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

We claim:

1. A method for providing industry-related research, community, design, and purchasing services over a computer network comprising the steps of:
receiving, from a client computer associated with a user, a request to view a home page associated with a service provider;
displaying the home page to the client computer, wherein the home page includes thereon at least the following options: a research option, an interact option, a design option, and a buy option;
receiving a request, from the client computer, to select a selected one of the research, interact, design, and buy options; and
displaying, to the client computer, content associated with the selected one of the research, interact, design, and buy options.

2. The method of claim 1, further comprising the steps of:
receiving a request from the client computer to select the research option;
displaying, to the client computer, a plurality of research-related options including at least: a technical answer center option; a technical facts option; a processing and design guides option; a glossary option; and a datasheets option;
receiving a request, from the client computer, to select a selected one of the research-related options; and
displaying, to the client computer, content associated with the selected one of the research-related options.

3. The method of claim 1, further comprising the steps of:
receiving a request from the client computer to select the interact option;
displaying, to the client computer, a plurality of interaction-related options including at least: a career center option; a discussion groups option; an industry directory option; and a customizable home page option;
receiving a request, from the client computer, to select a selected one of the interaction-related options; and
displaying, to the client computer, content associated with the selected one of the interaction-related options.

4. The method of claim 1, further comprising the steps of:
receiving a request from the client computer to select the design option;
displaying, to the client computer, a plurality of design-related options including at least: a concept option; a design option; a production option; a secondary operations option; a toolbox option; a develop option; and a material selection option.
receiving a request, from the client computer, to select a selected one of the design-related options; and
displaying, to the client computer, content associated with the selected one of the design-related options.

5. The method of claim 1, further comprising the steps of:
receiving a request from the client computer to select the buy option;
displaying, to the client computer, a plurality of purchasing-related options including at least: a general order center option; an order now option; an order status option; a shipment tracking option; an order wizard option; a pricing and availability option; a buying history option; an issue submission option; an invoice reprint option; a material certifications option; a material safety data sheets option; and an auction option;
receiving a request, from the client computer, to select a selected one of the purchasing-related options; and
displaying, to the client computer, content associated with the selected one of the purchasing-related options.

6. A server in communication with a computer network including a plurality of user computer terminals, the server including a memory storing machine readable computer code comprising:
one or more instructions for receiving, from at least one of the user computer terminals, a request to view a home page associated with a service provider;
one or more instructions for displaying the home page to the at least one user computer terminal, wherein the home page includes thereon at least the following options: a research option, an interact option, a design option, and a buy option;
one or more instructions for receiving a request, from the at least one user computer terminal, to select a selected one of the research, interact, design, and buy options; and
one or more instructions for displaying, to the at least one user computer terminal, content associated with the selected one of the research, interact, design, and buy options.

7. The server of claim 6, wherein the machine readable computer code further comprises:
one or more instructions for receiving a request from the client computer to select the research option;
one or more instructions for displaying, to the client computer, a plurality of research-related options including at least: a technical answer center option; a technical facts option; a processing and design guides option; a glossary option; and a datasheets option;
one or more instructions for receiving a request, from the client computer, to select a selected one of the research-related options; and
one or more instructions for displaying, to the client computer, content associated with the selected one of the research-related options.

8. The server of claim 6, wherein the machine readable computer code further comprises:
one or more instructions for receiving a request from the client computer to select the interact option;
one or more instructions for displaying, to the client computer, a plurality of interaction-related options including at least: a career center option; a discussion groups option; an industry directory option; and a customizable home page option;
one or more instructions for receiving a request, from the client computer, to select a selected one of the interaction-related options; and
one or more instructions for displaying, to the client computer, content associated with the selected one of the interaction-related options.

9. The server of claim 6, wherein the machine readable computer code further comprises:
one or more instructions for receiving a request from the client computer to select the design option;
one or more instructions for displaying, to the client computer, a plurality of design-related options including at least: a concept option; a design option; a production option; a secondary operations option; a toolbox option; a develop option; and a material selection option.
receiving a request, from the client computer, to select a selected one of the design-related options; and
displaying, to the client computer, content associated with the selected one of the design-related options.

10. The server of claim 6, wherein the machine readable computer code further comprises:
one or more instructions for receiving a request from the client computer to select the buy option;
one or more instructions for displaying, to the client computer, a plurality of purchasing-related options including at least: a general order center option; an order now option; an order status option; a shipment tracking option; an order wizard option; a pricing and availability option; a buying history option; an issue submission option; an invoice reprint option; a material certifications option; a material safety data sheets option; and an auction option;
one or more instructions for receiving a request, from the client computer, to select a selected one of the purchasing-related options; and
one or more instructions for displaying, to the client computer, content associated with the selected one of the purchasing-related options.

11. A system for enabling industry-related research, community, design, and purchasing services over a computer network comprising:
a server associated with a service provider, said server hosting at least one web page;
a client computer associated with a user; said client computer being connected to the server through the computer network for access to the at least one web page;
said server including means for receiving, from the client computer, a request to view a home page;
said server including means for displaying the home page to the client computer, wherein the home page includes thereon at least the following options: a research option, an interact option, a design option, and a buy option;
said server including means for receiving a request, from the client computer, to select a selected one of the research, interact, design, and buy options; and
said server including means for displaying, to the client computer, content associated with the selected one of the research, interact, design, and buy options.

12. The system of claim 11, wherein said server further comprises:
means for receiving a request from the client computer to select the research option;
means for displaying, to the client computer, a plurality of research-related options including at least: a technical answer center option; a technical facts option; a processing and design guides option; a glossary option; and a datasheets option;
means for receiving a request, from the client computer, to select a selected one of the research-related options; and
means for displaying, to the client computer, content associated with the selected one of the research-related options.

13. The system of claim 11, wherein said server further comprises:
means for receiving a request from the client computer to select the interact option;
means for displaying, to the client computer, a plurality of interaction-related options including at least: a career center option; a discussion groups option; an industry directory option; and a customizable home page option;
means for receiving a request, from the client computer, to select a selected one of the interaction-related options; and
means for displaying, to the client computer, content associated with the selected one of the interaction-related options.

14. The system of claim 11, wherein said server further comprises:
means for receiving a request from the client computer to select the design option;
means for displaying, to the client computer, a plurality of design-related options including at least: a concept option; a design option; a production option; a secondary operations option; a toolbox option; a develop option; and a material selection option.
means for receiving a request, from the client computer, to select a selected one of the design-related options; and
means for displaying, to the client computer, content associated with the selected one of the design-related options.

15. The system of claim 1, wherein said server further comprises:
means for means for receiving a request from the client computer to select the buy option;
means for displaying, to the client computer, a plurality of purchasing-related options including at least: a general order center option; an order now option; an order status option; a shipment tracking option; an order wizard option; a pricing and availability option; a buying history option; an issue submission option; an invoice reprint option; a material certifications option; a material safety data sheets option; and an auction option;
means for receiving a request, from the client computer, to select a selected one of the purchasing-related options; and
means for displaying, to the client computer, content associated with the selected one of the purchasing-related options.

16. A method for developing a product over a computer network comprising the steps of:
initiating product development of a product including at least one material;
navigating, across the computer network, to a service provider home page, wherein the home page includes thereon at least the following options: a research option, an interact option, a design option, and a buy option;
selecting the research option and conducting research regarding the product;
selecting the interact option and interacting with other users regarding the product;
determining whether sufficient information has been learned to advance to a design stage;
if it is determined that sufficient information has been learned to advance to the design stage, selecting the design option and using available tools and information to design the product; and
selecting a buy option and purchasing the necessary materials for fabricating the designed product.
